(19) United States
(12) Patent Application Publication
(10) Pub. No.: US 2003/0205588 A1
(43) Pub. Date: Nov. 6, 2003

(54) Apparatus for dispensing flowable material

(76) Inventors: David Lee Mainous, Hamilton, OH (US); Clark Louis Brown, South Lebanon, OH (US)

Correspondence Address: Killworth, Gottman, Hagan & Schaeff, L.L.P., Suite 500, One Dayton Centre, Dayton, OH, 45402-2023, US

(21) Appl. No.: 10/308,406

(22) Filed: Dec. 3, 2002

Related U.S. Application Data
(60) Provisional application No. 60/376,860, filed on May 1, 2002.

(51) Int. Cl. B67D 3/00

(52) U.S. Cl. 222/504

(57) ABSTRACT

An apparatus for dispensing a repeatable volume of flowable material. The apparatus comprises a fluid cylinder body, a piston, a meter body, and at least one valve. The fluid cylinder body includes a fluid chamber, a fluid supply, and a pair of fluid pressure channels. The meter body is positioned adjacent the fluid cylinder body and includes a displacement chamber, a flowable material supply, an outlet valve, an inlet valve, and a flowable material outlet. The piston defines a piston head and a piston stem. The piston head is positioned within the fluid chamber and the piston stem extends laterally from the fluid chamber into the meter body. The valve is positioned adjacent the fluid cylinder body. It is emphasized that this abstract is provided to comply with the rules requiring an abstract which will allow a searcher or other reader to quickly ascertain the subject matter of the technical disclosure. It is submitted with the understanding that is will not be used to interpret or limit the scope or meaning of the claims. 37 C.F.R. §1.72(b).

### CROSS-REFERENCE TO RELATED APPLICATION

This application claims the benefit of U.S. Provisional Patent Application Serial No. 60/376,860, MICROSHOT METER, filed May 1, 2002.

### BACKGROUND OF THE INVENTION

The present invention relates generally to fluid dispensing systems and, more particularly, to an apparatus for dispensing a repeatable volume of flowable material through positive-displacement.

Pressure-driven or direct solenoid activated fluid dispensing systems meter material from the material source for dispensing through a nozzle. These systems employ a series of pressurized hoses to deliver material to a dispensing valve. The present inventors have recognized a need for an improved valve and meter assembly for fluid dispensing systems.

### SUMMARY OF THE INVENTION

The present invention meets this need by providing an apparatus for dispensing a precise and repeatable volume of flowable material through positive-displacement, independent of supply pressure and nozzle back pressure.

The present inventors have recognized that the volume of material that is dispensed from pressure-driven fluid dispensing systems often varies due to changes in material temperature, pressure, and/or viscosity. Also, the pressurized hoses employed in these systems suffer from an “accumulator effect” wherein the hoses delivering material to the dispensing valve swell in diameter as pressure increases. Excess material can accumulate within the system causing uncontrolled delivery that results in an imprecise volume of material being applied to a work piece. Moreover, the orifices employed in the prior art systems are often too large for certain applications and, if made smaller, commonly become obstructed.

Although the present invention is not limited to specific advantages or functionality, it is noted that the apparatus effectively and rapidly ejects a repeatable volume of flowable material through a low coefficient of friction flowable material outlet, which is resistant to clogging and is not affected by changes in the material being dispensed. The apparatus can be provided in a relatively small package and is stackable with additional units to allow the ejection of flowable material in multiple, closely spaced beads. In addition, the present invention exhibits at least one valve that is positioned adjacent a fluid cylinder body. This enables a response time between a signal to dispense and the actual dispensing of flowable material to be much quicker than remotely mounted solenoid valves of the prior art, which require the activation air to travel a further distance. Moreover, the apparatus produces a high fluid to flowable material pressure ratio, enabling increased ejection velocity and ejection of flowable material over a large standoff distance.

In accordance with one embodiment of the present invention, an apparatus for dispensing a repeatable volume of flowable material is provided comprising a fluid cylinder body, a meter body, a piston, and at least one valve. The fluid cylinder body includes a fluid chamber, a fluid supply, and a pair of fluid pressure channels. The meter body is positioned adjacent the fluid cylinder body and includes a displacement chamber, a flowable material supply, an outlet valve, an inlet valve, and a flowable material outlet. The piston defines a piston head and a piston stem. The piston head is positioned within the fluid chamber and the piston stem extends laterally from the fluid chamber into the meter body. The valve is positioned adjacent the fluid cylinder body.

In accordance with another embodiment of the present invention, an apparatus for dispensing a repeatable volume of flowable material is provided comprising a fluid cylinder body, a meter body, a piston, a seal retainer, and at least one valve. The fluid cylinder body includes a fluid chamber, a fluid supply, a pair of fluid pressure channels, and a fluid cylinder cap. The meter body is positioned adjacent the fluid cylinder body and includes a displacement chamber, a flowable material supply, an outlet valve, an inlet valve, and a flowable material outlet. The piston defines a piston head and a piston stem. The piston head is positioned within the fluid chamber and the piston stem extends laterally from the fluid chamber into the meter body. The seal retainer is positioned adjacent the piston stem and comprises a shaft seal. The valve is positioned adjacent the fluid cylinder body.

In accordance with still another embodiment of the present invention, an apparatus for dispensing a repeatable volume of flowable material is provided comprising a fluid cylinder body, a meter body, a piston, and at least one valve. The fluid cylinder body includes a fluid chamber, a fluid supply, and a pair of fluid pressure channels. The meter body is positioned adjacent the fluid cylinder body and includes a displacement chamber, a flowable material supply, an outlet valve, an inlet valve, and a flowable material outlet. The outlet valve is in communication with the displacement chamber and the flowable material outlet, and is configured to allow the flowable material to flow out of the flowable material outlet during a dispense cycle. The outlet valve is further configured to retain the flowable material within the displacement chamber during a refill cycle and while the apparatus is at rest. The piston defines a piston head and a piston stem. The piston head is positioned within the fluid chamber and the piston stem extends laterally from the fluid chamber into the meter body. The valve is positioned adjacent the air cylinder body.

In accordance with yet another embodiment of the present invention, an apparatus for dispensing a repeatable volume of flowable material is provided comprising a fluid cylinder body, a meter body, a piston, and at least one valve. The fluid cylinder body includes a fluid chamber, a fluid supply, and a pair of fluid pressure channels. The pair of fluid pressure channels are in communication with the fluid supply and the fluid chamber. The meter body is positioned adjacent the fluid cylinder body and includes a displacement chamber, a flowable material supply, an outlet valve, an inlet valve, and a flowable material outlet. The flowable material supply is in communication with the displacement chamber. The piston defines a piston head and a piston stem. The piston head is positioned within the fluid chamber and the piston stem extends laterally from the fluid chamber into the meter body. The valve is positioned adjacent the fluid cylinder body and the fluid supply is in communication with the valve. The valve is in communication with the pair of fluid pressure channels.

In accordance with yet still another embodiment of the present invention, an apparatus for dispensing a repeatable volume of flowable material is provided comprising a fluid cylinder body, a meter body, a piston, and at least one valve. The fluid cylinder body includes a fluid chamber, a fluid supply, and a pair of fluid pressure channels. The meter body is positioned adjacent the fluid cylinder body and includes a displacement chamber, a flowable material supply, an outlet valve, an inlet valve, and a flowable material outlet. The piston defines a piston head and a piston stem. The piston head is positioned within the fluid chamber and divides the fluid chamber into a fluid dispensing chamber and a fluid refilling chamber. The piston stem extends laterally from the fluid chamber into the meter body. The valve is positioned adjacent the fluid cylinder body.

In accordance with yet still another embodiment of the present invention, an apparatus for dispensing a repeatable volume of flowable material is provided comprising a pneumatic cylinder body, a meter body, a piston, and a solenoid valve. The pneumatic cylinder body includes an air chamber, an air supply, and a pair of air pressure channels. The meter body is positioned adjacent the pneumatic cylinder body and includes a displacement chamber, a flowable material supply, an outlet valve, an inlet valve, and a flowable material outlet. The piston defines a piston head and a piston stem. The piston head is positioned within the air chamber and the piston stem extends laterally from the air chamber into the meter body. The solenoid valve is positioned adjacent the pneumatic cylinder body.

In accordance with yet still another embodiment of the present invention, an apparatus for dispensing a repeatable volume of flowable material is provided comprising a hydraulic cylinder body, a meter body, a piston, and at least one valve. The hydraulic cylinder body includes a liquid chamber, a liquid supply, and a pair of liquid pressure channels. The meter body is positioned adjacent the hydraulic cylinder body and includes a displacement chamber, a flowable material supply, an outlet valve, an inlet valve, and a flowable material outlet. The piston defines a piston head and a piston stem. The piston head is positioned within the liquid chamber and the piston stem extends laterally from the liquid chamber into the meter body.

These and other features and advantages of the invention will be more fully understood from the following detailed description of a typical embodiment of the present invention, taken together with the accompanying drawing, and the appended claims. It is noted that the scope of the claims is defined by the recitations therein and not by the discussion of features and advantages set forth in the present description.

### BRIEF DESCRIPTION OF THE DRAWING

The following detailed description of the embodiments of the present invention can be best understood when read in conjunction with the following drawing, where like structure is indicated with like reference numerals and in which:

FIG. 1 is a detailed illustration of an apparatus for dispensing a repeatable volume of flowable material according to the present invention.

Skilled artisans appreciate that elements in the figure are illustrated for simplicity and clarity and have not necessarily been drawn to scale. For example, the dimensions of some of the elements in the figure may be exaggerated relative to other elements to help improve understanding of the embodiment(s) of the present invention.

### DETAILED DESCRIPTION OF THE EMBODIMENTS OF THE INVENTION

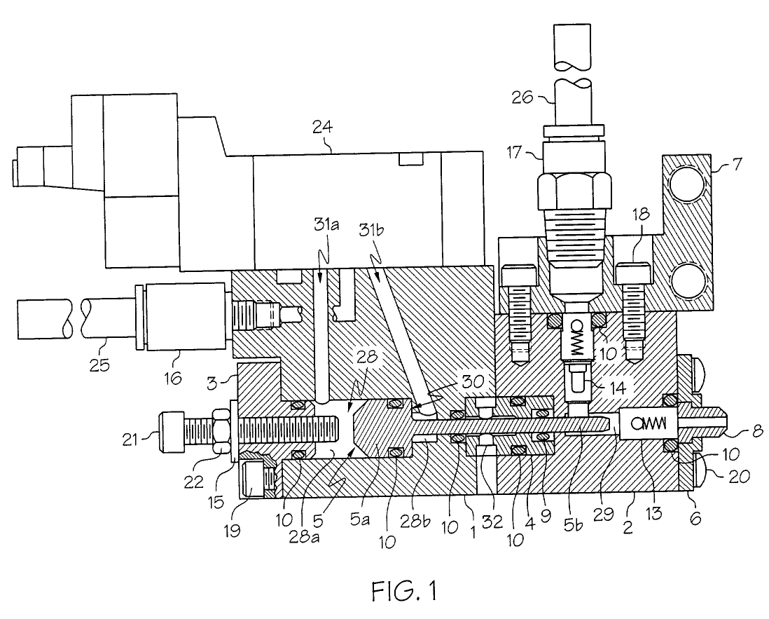

With reference to FIG. 1, a fluid cylinder body 1, a meter body 2, a piston 5, and a valve 24, all in accordance with one exemplary embodiment of the present invention, are illustrated. The apparatus as a whole can be provided as a relatively small package having a thin profile. Although it is not the inventors' intent to limit the invention to any particular size, the apparatus, for example, can have the approximate dimensions of about 12 mm by about 116 mm by about 64 mm.

The fluid cylinder body 1 includes a fluid chamber 28, a fluid supply 25, and a pair of fluid pressure channels 31a, 31b. The piston 5 defines a piston head 5a and a piston stem 5b. The piston head 5a is positioned within the fluid chamber 28, which is contained within the fluid cylinder body 1. The piston stem 5b extends laterally from the fluid chamber 28 within the fluid cylinder body I into the meter body 2. As defined in more detail herein, the piston 5 travels fore and aft, laterally within the apparatus, in response to applied fluid pressure, which can be either pneumatic (air) or hydraulic (liquid) pressure. The apparatus can further comprise a seal retainer 4 that guides the piston stem 5b at the site where the piston stem 5b transects the interface between the fluid cylinder body 1 and the meter body 2. As illustrated in FIG. 1, the seal retainer 4 can define a weep hole 32. Should a seal failure occur, the weep hole 32 allows flowable material to exit the meter body 2, thus preventing the pressurization of the fluid chamber 28 with high-pressure flowable material.

The present invention can further comprise a fluid cylinder cap 3 that is secured to the fluid cylinder body I to form the fluid chamber 28 by at least two socket head cap screws 19. The socket head cap screws 19 extend through the fluid cylinder body 1 to the meter body 2 and hold the fluid cylinder cap 3, fluid cylinder body 1, and the meter body 2 together. The socket head cap screws 19 can be about 1-⅜″ long. It is further contemplated that any means of fastening the fluid cylinder body 1, the meter body 2, and the fluid cylinder cap 3 together can be employed. For example, a hex head screw or a threaded rod with an accompanying socket-type nut can be used as an optional means for fastening. However, the socket head cap screw 19 has a head that fits within an area that is smaller than what is required for the optional means for fastening. Moreover, although the fluid cylinder body 1 is illustrated in FIG. 1 as a one-piece design, a two-piece fluid cylinder body is also contemplated.

The fluid cylinder cap 3 can comprise a threaded passage that transects the width of the fluid cylinder cap 3. An adjustable screw 21 can be positioned within the threaded passage. The adjustable screw 21 extends into the fluid chamber 28. The fluid cylinder cap 3 can further comprise a nut 22 that secures the adjustable screw 21 within the fluid cylinder cap 3. A thread seal 15 can also be provided to ensure that fluid (air or liquid) does not escape from the fluid chamber 28 through the threaded passage embodied within the fluid cylinder cap 3. The adjustable screw 21 can be about 1″ long.

The meter body 2 includes a displacement chamber 29, a flowable material supply 26, an outlet valve 13, an inlet valve 14, and a flowable material outlet 8. The flowable material outlet 8 can be a nozzle comprised of a ceramic material or an alternate material having a low coefficient of friction and minimal adhesion properties. By “minimal adhesion properties” we mean that the flowable material which travels through and exits the outlet 8 is not likely to adhere to the outlet 8. The low coefficient of friction and minimal adhesion properties of the flowable material outlet 8 allows for high extrusion velocities and resists clogging of the outlet 8. An inlet adapter 7 can be secured to the meter body 2 by at least one socket head cap screw 18, which can be about ⅜″ long. The flowable material outlet 8 can be secured to the meter body 2 by an adapter 6 and at least two button head cap screws 20. The button head cap screws 20 can be about ⅜″ long. However, other means for fastening are contemplated and it is not the inventors' intent to limit the invention to any particular fastening means.

The outlet and inlet valves 13, 14 can be cartridge-type check valves. The outlet valve 13 is positioned between the displacement chamber 29 and the flowable material outlet 8. Flowable material for the present invention can be maintained in a separate reservoir (not shown) and supplied to the meter body 2 by the flowable material supply 26. Typically, the flowable material dispensed by the apparatus is a liquid adhesive such as hot-melt and cold-glue adhesives, among others. However, the material dispensed by the present invention is not limited to any particular media and, accordingly, can be any flowable material now known or later developed that is capable of being dispensed through a system employing positive-displacement.

The flowable material supply 26 can be a material supply tube, which can be comprised of a polymeric material such as a transparent urethane or polyurethane material. Typically, the material supply tube has an outside diameter of about ¼″ (6 mm). As illustrated in FIG. 1, the flowable material supply 26 is in communication with the displacement chamber 29. The flowable material supply 26 can be in communication with a male material connector 17, which is in communication with the inlet valve 14. The male material connector 17 can be positioned within the inlet adapter 7 and the inlet valve 14 is configured to deliver flowable material to the displacement chamber 29. The flowable material is supplied to the displacement chamber 29 under pressure that creates a supply pressure within the displacement chamber 29.

In a pneumatic system, pressurized air can be generated by a distant source, such as a compressor (not shown), and is supplied to the fluid chamber 28 through a fluid supply 25 to create a dispense pressure within the fluid chamber 28. The fluid supply 25 can comprise a fluid pressure supply tube, which can be comprised of a polymeric material such as a black or opaque urethane or polyurethane material. Typically, the fluid pressure supply tube has an outside diameter of about ¼″ (6 mm). As illustrated in FIG. 1, the fluid supply 25 is in communication with the valve 24, which is in communication with the pair of fluid pressure channels 31a, 31b. Accordingly, the fluid supply 25 is in communication with the pair of fluid pressure channels 31a, 31b, which are in communication with the fluid chamber 28. In addition, the fluid supply 25 can be in communication with a male fluid connector 16, which is secured to the fluid cylinder body 1 and is in communication with the valve 24. The pressure ratio developed between the fluid chamber 28 and displacement chamber 29 can be between about 4:1 and about 64:1. More typically, the pressure ratio is about 16:1, which is effective in clearing debris or partially cured material from the flowable material outlet 8.

A plurality of O-rings 10 are positioned throughout the present invention and are configured to block fluid flow (flowable material, air, and/or liquid). The O-rings can be either static seal-type (non-moving) or dynamic seal-type (moving) o-rings, which can include molybdenum for better lubricity. A shaft seal 9 can be positioned adjacent to the piston stem 5b and is configured to block the flow of material from exiting the displacement chamber 29 at an end opposite the outlet valve 13.

The piston head 5a divides the fluid chamber 28 into two separate chambers—a fluid dispensing chamber 28a and a fluid refilling chamber 28b. The fluid refilling chamber 28b is defined between the piston head 5a and a forward wall of the fluid chamber 28. By “forward wall” we mean the wall of the fluid chamber 28 that is closest to the flowable material outlet 8. The fluid dispensing chamber 28a is defined between the piston head 5a and a rearward wall of the fluid chamber 28, which can be the fluid cylinder cap 3. The pair of fluid pressure channels 31a, 31b define a first fluid pressure channel 31a and a second fluid pressure channel 31b. The first fluid pressure channel 31a is defined between the valve 24 and the fluid dispensing chamber 28a, while the second fluid pressure channel 31b is defined between the valve 24 and the fluid refilling chamber 28b.

The valve 24 is positioned adjacent the fluid cylinder body 1 and typically comprises a DC voltage, 4-way solenoid valve, which can further comprise a plug connector including leads. The valve 24 is employed to control the distribution of fluid between the pair of fluid pressure channels 31a, 31b in response to an electronic signal. In a hydraulic system, additional valves can be employed to control the distribution of liquid between the pair of fluid pressure channels 31a, 31b. Because the valve 24 is positioned adjacent the fluid cylinder body 1, the response time between the signal to dispense and the actual dispensing of flowable material is much quicker than remotely mounted solenoid valves of the prior art, which require the pressurized activation air to travel a further distance. Consequently, virtually any type of valve can be incorporated into the present invention, which is positioned adjacent the fluid cylinder body 1, and which effectively distributes fluid pressure between the pair of fluid pressure channels 31a, 31b.

In operation, the piston 5 will travel alternatively between a dispensed position and a refilled position for dispense and refill processes. In the embodiment illustrated in FIG. 1, the piston 5 is in the dispensed position, wherein the piston head 5a is oriented adjacent a stop wall 30 that is defined within the fluid chamber 28, and more specifically, within the fluid refilling chamber 28b. In order to refill the displacement chamber 29 with flowable material for delivery of a shot, fluid pressure is employed to move the piston 5 within the apparatus by manipulating the piston head 5a within the fluid chamber 28 by either pneumatic or hydraulic means. Fluid pressure provided by the fluid supply 25 is directed by the valve 24 into the second fluid pressure channel 31b, that is in fluid communication with the fluid refilling chamber 28b. Here, the fluid presses against the piston head 5a to move the piston 5 into the refilled position. In this position, the piston head 5a will rest against a rearward wall of the fluid chamber 28, or the adjustable screw 21, which extends through the fluid cylinder cap 3. The position of the piston 5 can be adjusted by turning the screw 21, however, non-adjustable designs have also been contemplated. The position of the adjustable screw 21 affects the travel distance of the piston 5 and, consequently, the potential volume of the displacement chamber 29. The volume of the displacement chamber 29, which can be, but is not limited to, between 0 and about 0.0017 cubic inches (about 0.025 cc), determines the dispense volume of the flowable material shot that is delivered by the piston stem 5b through positive-displacement.

As the piston head 5a moves into the refilled position, the inlet valve 14 will allow material, which is under pressure, to flow into and fill the displacement chamber 29. Next, during dispensing, fluid pressure provided by the fluid supply 25 is directed by the valve 24 into the first fluid pressure channel 31a, which is in communication with the fluid dispensing chamber 28a. Here, the fluid presses against the piston head 5a to move the piston stem 5b through the displacement chamber 29 in the direction of the flowable material outlet 8, thereby expressing material through the outlet 8 by way of positive-displacement. The outlet valve 13, which is in communication with the displacement chamber 29 and the flowable material outlet 8, allows material to flow outward during the dispense cycle, while preventing material from flowing out of the displacement chamber 29 during both the refill cycle and while the apparatus is at rest.

Unlike on/off valves of the prior art whereby the flow of pressurized material and/or fluid is controlled by electric means, fluid pressure applied against the piston head 5a is used to generate dispense pressures within the fluid chamber 28 that are greater than the supply pressure within the displacement chamber 29. The potential pressure of the flowable material and the design of the low coefficient of friction flowable material outlet 8 allows material to be ejected over a large standoff distance, which can be up to about 48″, but is typically at least about 0.10″. The precise standoff distance will be determined according to manufacturing specifications requiring repeated delivery of a consistent volume of flowable material.

In accordance with another embodiment of the present invention, an apparatus for dispensing a repeatable volume of flowable material is provided comprising a meter body, a piston, and a solenoid valve all as described herein, as well as a pneumatic cylinder body including an air chamber, an air supply, and a pair of air pressure channels. The solenoid valve is positioned adjacent the pneumatic cylinder body. The pneumatic cylinder body has a design that is consistent with the fluid cylinder body of the present invention, and employs pressurized air to drive the piston within the air chamber for delivery of flowable material through the outlet.

In accordance with still another embodiment of the present invention, an alternate apparatus for dispensing a repeatable volume of flowable material is provided comprising a meter body and piston as described herein, at least one valve, and a hydraulic cylinder body including a liquid chamber, a liquid supply, and a pair of liquid pressure channels. The hydraulic cylinder body has a design that is consistent with the fluid cylinder body of the present invention, and employs hydraulic pressure though a non-compressible liquid such as oil to drive the piston within the liquid chamber for delivery of flowable material through the outlet.

In accordance with the present invention, it is further contemplated that multiple dispensing apparatus can be stacked or otherwise mounted side-by-side to deliver flowable material in a plurality of closely-spaced beads or shots. Each individual apparatus within the stack comprises its own separate flowable material outlet.

Further contemplated is the replacement of the o-ring 10 at the piston head 5a with a diaphragm, which can be fixed at its outer periphery to the walls of the fluid chamber 28, and which flexes allowing movement of the piston 5 for delivery of flowable material. Optional embodiments comprising a similar meter with an adjacent 3-way solenoid valve, an electronic solenoid which manipulates the piston 5 via electricity, as well as a meter comprising a spring return for refill are still further contemplated, all producing benefits similar to that of the embodiment illustrated in FIG. 1.

While the invention has been described by reference to certain typical embodiments, it should be understood that numerous changes could be made within the spirit and scope of the inventive concepts described. Accordingly, it is intended that the invention not be limited to the disclosed embodiments, but that it have the full scope permitted by the language of the following claims.

We claim:

1. An apparatus for dispensing a repeatable volume of flowable material comprising:
a fluid cylinder body including a fluid chamber, a fluid supply, and a pair of fluid pressure channels;
a meter body positioned adjacent said fluid cylinder body, said meter body including a displacement chamber, a flowable material supply, an outlet valve, an inlet valve, and a flowable material outlet;
a piston defining a piston head and a piston stem, wherein said piston head is positioned within said fluid chamber, and wherein said piston stem extends laterally from said fluid chamber into said meter body; and
at least one valve positioned adjacent said fluid cylinder body.

2. The apparatus of claim 1 further comprising a seal retainer, wherein said seal retainer guides said piston stem at a site where said piston stem transects an interface between said fluid cylinder body and said meter body.

3. The apparatus of claim 2 wherein said seal retainer further comprises a shaft seal positioned adjacent said piston stem, and wherein said shaft seal is configured to block said flowable material from exiting said displacement chamber.

4. The apparatus of claim 2 wherein said seal retainer further defines a weep hole, and wherein said weep hole is configured to allow said flowable material to exit said meter body.

5. The apparatus of claim 1 further comprising a fluid cylinder cap.

6. The apparatus of claim 5 wherein said fluid cylinder cap comprises a threaded passage that transects the width of said fluid cylinder cap, and wherein said fluid cylinder cap further comprises an adjustable screw positioned within said threaded passage.

7. The apparatus of claim 6 wherein said adjustable screw transects the width of said fluid cylinder cap to extend into said fluid chamber.

8. The apparatus of claim 6 wherein said fluid cylinder cap further comprises a nut that is configured to secure said adjustable screw within said fluid cylinder cap.

9. The apparatus of claim 6 wherein said fluid cylinder cap further comprises a thread seal that is configured to block the flow of fluid through said threaded passage.

10. The apparatus of claim 1 wherein said flowable material outlet comprises a nozzle.

11. The apparatus of claim 10 wherein said nozzle comprises a ceramic material.

12. The apparatus of claim 11 wherein said ceramic material has a low coefficient of friction, and wherein said ceramic material exhibits minimal adhesion properties.

13. The apparatus of claim 1 further comprising an adapter that is configured to secure said flowable material outlet to said meter body.

14. The apparatus of claim 1 wherein said inlet valve and said outlet valve are cartridge-type check valves.

15. The apparatus of claim 1 wherein:
said outlet valve is in communication with said displacement chamber and said flowable material outlet,
said outlet valve is configured to allow said flowable material to flow out of said flowable material outlet during a dispense cycle, and
said outlet valve is further configured to retain said flowable material within said displacement chamber during a refill cycle and while said apparatus is at rest.

16. The apparatus of claim 1 wherein said meter body further comprises an inlet adapter.

17. The apparatus of claim 1 wherein said flowable material supply is in communication with said displacement chamber.

18. The apparatus of claim 1 further comprising a male material connector in communication with said inlet valve, wherein said inlet valve is in communication with said displacement chamber.

19. The apparatus of claim 18 wherein said flowable material supply is in communication with said male material connector.

20. The apparatus of claim 1 wherein said flowable material supply comprises a material supply tube.

21. The apparatus of claim 20 wherein said material supply tube has an outside diameter of about 6 mm.

22. The apparatus of claim 20 wherein said material supply tube is comprised of a polymeric material.

23. The apparatus of claim 22 wherein said polymeric material is transparent.

24. The apparatus of claim 22 wherein said polymeric material comprises urethane or polyurethane.

25. The apparatus of claim 1 wherein said flowable material is a liquid adhesive.

26. The apparatus of claim 25 wherein said liquid adhesive is selected from a hot-melt adhesive, a cold-glue adhesive, and combinations thereof.

27. The apparatus of claim 1 wherein said pair of fluid pressure channels are in communication with said fluid supply, and wherein said pair of fluid pressure channels are in communication with said fluid chamber.

28. The apparatus of claim 1 wherein said fluid supply is in communication with said valve, and wherein said valve is in communication with said pair of fluid pressure channels.

29. The apparatus of claim 28 further comprising a male fluid connector in communication with said fluid supply, wherein said male fluid connector is in communication with said valve.

30. The apparatus of claim 1 wherein said fluid supply comprises a fluid pressure supply tube.

31. The apparatus of claim 30 wherein said fluid pressure supply tube has an outside diameter of about 6 mm.

32. The apparatus of claim 30 wherein said fluid pressure supply tube is comprised of a polymeric material.

33. The apparatus of claim 32 wherein said polymeric material is opaque or black.

34. The apparatus of claim 32 wherein said polymeric material comprises urethane or polyurethane.

35. The apparatus of claim 1 wherein said apparatus is configured to define a pressure ratio between said fluid chamber and said displacement chamber.

36. The apparatus of claim 35 wherein said pressure ratio is sufficient to clear debris or partially cured material from said flowable material output, upon application of fluid pressure against said piston head.

37. The apparatus of claim 35 wherein said pressure ratio is between about 4:1 and about 64:1.

38. The apparatus of claim 37 wherein said pressure ratio is about 16:1.

39. The apparatus of claim 1 further comprising at least one o-ring positioned within said apparatus and configured to block the flow of fluid, wherein said at least one o-ring is selected from a static seal-type o-ring, a dynamic seal-type o-ring, and combinations thereof.

40. The apparatus of claim 39 wherein said at least one o-ring is a dynamic seal-type o-ring comprising molybdenum.

41. The apparatus of claim 1 further comprising a plurality of O-rings positioned throughout said apparatus and configured to block the flow of fluid, wherein said plurality of O-rings are selected from static seal-type o-rings, dynamic seal-type o-rings, and combinations thereof.

42. The apparatus of claim 41 wherein at least one of said plurality of O-rings is a dynamic seal-type o-ring comprising molybdenum.

43. The apparatus of claim 1 wherein said piston head divides said fluid chamber into a fluid dispensing chamber and a fluid refilling chamber, wherein said fluid dispensing chamber is defined between said piston head and a rearward wall of said fluid chamber, and wherein said fluid refilling chamber is defined between said piston head and a forward wall of said fluid chamber.

44. The apparatus of claim 43 wherein said reward wall defines a fluid cylinder cap.

45. The apparatus of claim 43 wherein said pair of fluid pressure channels define a first fluid pressure channel and a second fluid pressure channel, wherein said first fluid pressure channel is defined between said valve and said fluid dispensing chamber, and wherein said second fluid pressure channel is defined between said valve and said fluid refilling chamber.

46. The apparatus of claim 1 wherein said valve is configured to control the distribution of fluid between said pair of fluid pressure channels.

47. The apparatus of claim 1 wherein said piston is configured to travel alternatively between a dispensed position wherein said piston head is oriented adjacent a stop wall defined within said fluid chamber, and a refilled position wherein said piston head is oriented adjacent a rearward wall of said fluid chamber.

48. The apparatus of claim 47 wherein said rearward wall comprises a fluid cylinder cap including an adjustable screw that transects said fluid cylinder cap, and wherein in said refilled position said piston head is oriented adjacent said adjustable screw.

49. The apparatus of claim 48 wherein said adjustable screw affects a travel distance of said piston stem and a volume of flowable material within said displacement chamber.

50. The apparatus of claim 49 wherein said volume is between about 0 and about 0.025 cc.

51. The apparatus of claim 1 wherein said fluid cylinder body is configured to define a dispense pressure within said fluid chamber that is greater than a supply pressure within said displacement chamber.

52. The apparatus of claim 1 wherein said flowable material outlet is configured to eject fluid over a standoff distance of at least about 0.10″.

53. The apparatus of claim 1 further comprising a plurality of said apparatus that are stacked or mounted side-by-side for delivering said flowable material in a plurality of closely spaced beads or shots.

54. An apparatus for dispensing a repeatable volume of flowable material comprising:
a fluid cylinder body including a fluid chamber, a fluid supply, a pair of fluid pressure channels, and a fluid cylinder cap;
a meter body positioned adjacent said fluid cylinder body, said meter body including a displacement chamber, a flowable material supply, an outlet valve, an inlet valve, and a flowable material outlet;
a piston defining a piston head and a piston stem, wherein said piston head is positioned within said fluid chamber, and wherein said piston stem extends laterally from said fluid chamber into said meter body;
a seal retainer positioned adjacent said piston stem, said seal retainer comprising a shaft seal; and
at least one valve positioned adjacent said fluid cylinder body.

55. An apparatus for dispensing a repeatable volume of flowable material comprising:
a fluid cylinder body including a fluid chamber, a fluid supply, and a pair of fluid pressure channels;
a meter body positioned adjacent said fluid cylinder body, said meter body including a displacement chamber, a flowable material supply, an outlet valve, an inlet valve, and a flowable material outlet,
wherein said outlet valve is in communication with said displacement chamber and said flowable material outlet,
wherein said outlet valve is configured to allow said flowable material to flow out of said flowable material outlet during a dispense cycle, and
wherein said outlet valve is further configured to retain said flowable material within said displacement chamber during a refill cycle and while said apparatus is at rest;
a piston defining a piston head and a piston stem, wherein said piston head is positioned within said fluid chamber, and wherein said piston stem extends laterally from said fluid chamber into said meter body; and
at least one valve positioned adjacent said fluid cylinder body.

56. An apparatus for dispensing a repeatable volume of flowable material comprising:
a fluid cylinder body including a fluid chamber, a fluid supply, and a pair of fluid pressure channels, wherein said pair of fluid pressure channels are in communication with said fluid supply and said fluid chamber;
a meter body positioned adjacent said fluid cylinder body, said meter body including a displacement chamber, a flowable material supply, an outlet valve, an inlet valve, and a flowable material outlet, wherein said flowable material supply is in communication with said displacement chamber;
a piston defining a piston head and a piston stem, wherein said piston head is positioned within said fluid chamber, and wherein said piston stem extends laterally from said fluid chamber into said meter body; and
at least one valve positioned adjacent said fluid cylinder body, wherein said fluid supply is in communication with said valve, and where is said valve is in communication with said pair of fluid pressure channels.

57. An apparatus for dispensing a repeatable volume of flowable material comprising:
a fluid cylinder body including a fluid chamber, a fluid supply, and a pair of fluid pressure channels;
a meter body positioned adjacent said fluid cylinder body, said meter body including a displacement chamber, a flowable material supply, an outlet valve, an inlet valve, and a flowable material outlet;
a piston defining a piston head and a piston stem, wherein said piston head is positioned within said fluid chamber and divides said fluid chamber into a fluid dispensing chamber and a fluid refilling chamber, and wherein said piston stem extends laterally from said fluid chamber into said meter body; and
at least one valve positioned adjacent said fluid cylinder body.

58. An apparatus for dispensing a repeatable volume of flowable material comprising:
a pneumatic cylinder body including an air chamber, an air supply, and a pair of air pressure channels;
a meter body positioned adjacent said pneumatic cylinder body, said meter body including a displacement chamber, a flowable material supply, an outlet valve, an inlet valve, and a flowable material outlet;
a piston defining a piston head and a piston stem, wherein said piston head is positioned within said air chamber, and wherein said piston stem extends laterally from said air chamber into said meter body; and
a solenoid valve positioned adjacent said pneumatic cylinder body.

59. An apparatus for dispensing a repeatable volume of flowable material comprising:
a hydraulic cylinder body including a liquid chamber, a liquid supply, and a pair of liquid pressure channels;
a meter body positioned adjacent said hydraulic cylinder body, said meter body including a displacement chamber, a flowable material supply, an outlet valve, an inlet valve, and a flowable material outlet;
a piston defining a piston head and a piston stem, wherein said piston head is positioned within said liquid chamber, and wherein said piston stem extends laterally from said liquid chamber into said meter body; and
at least one valve.
